(19) United States
(12) Patent Application Publication
(10) Pub. No.: US 2012/0260409 A1
(43) Pub. Date: Oct. 18, 2012

(54) Heat protection suit

(76) Inventor: David Ben Yair, Jerusalem (IL)

(21) Appl. No.: 13/085,872

(22) Filed: Apr. 13, 2011

(51) Int. Cl. A62B 17/00

(52) U.S. Cl. 2/458

(57) ABSTRACT

A suit for protection of a wearer's body from heat includes an inner suit encompassing the wearers' body, and an outer suit overlying the inner suit. There are a number of pockets with dry ice into them that are arranged between the inner and outer suits. These pockets are produced from thermo isolated materials. The pockets may have covers to open or to close the pockets.

### FIELD

The invention relates to body protection devices and, in particular, to a new and useful heat protection suit, including inner and outer suits and a cooling device with cooling agents.

### BACKGROUND

The human body generates heat continuously by metabolism. Normally this heat is transferred to the environment by radiation, conduction, convection and evaporation. The necessary equilibrium, at which the body temperature does not rise beyond the physiological limits, can be attained only if the ambient air can absorb the heat as quickly as it generated. Direct transfer of the heat from the body becomes impossible, however, if the surrounding air temperature becomes greater than the permissible upper limit of the human body temperature.

### DESCRIPTION OF THE PRIOR ART

O'Reilly (U.S. Pat. No. 3,500,827) discloses a portable environmental control system for protective garments for astronauts. In its heat insulating envelope an inner suit with tubular flow channels for the circulation of a liquid cooling agent is disposed. The respective cooling apparatus is accommodated in a backpack and comprises a vessel containing coolant. By the structural measures it is taken from the vessel and used via pressure regulating devices to drive the delivering pump for the cooling agent. The cooling agent flows from the pump through a heat exchanger disposed in the cooling vessel to the flow channels in the inner suit and thence back to the delivery pump. Liquid coolant, e.g. ammonia, is dangers to handle. The protective suit has a high weight, is complicated, and expensive.

Pasternack (U.S. Pat. Nos. 4,172,454 and 4,286,439) is similar to the suit according to O'Reilly, with dry ice as the coolant agent. This protective suit has high weight, is complicated and is expensive.

Blackstone (US Patent Application Publication 2005/178138) is a double-walled protective suit, provided with cooling liquid system. The cooling system of the suit is connected with outer cooling liquid cycle, in which a heat exchanger cooled by evaporating water. This suit does not allow to wearer to act independently of the outer cooling system.

Known further is a protective suit for soldiers, acting in environments with dangerous gases. This suit is produced from polymeric films. The suit, however, does not allow the transfer of heat and cannot be used in the sun or on a hot day. To avoid these problems, it uses an additional cotton suit, which has to be wet to cool the polymeric suit. It is not convenient and does not avoid the problems.

Another known protective suit for soldiers is produced from active carbon fibers to absorb the dangerous gases. This suit is too expensive and does not protect the wearer from hot.

It is a known problem for surgical doctors during operations (see Blackstone (US Patent Application Publication 2005/178138)). For better transferring heat, it uses a suit with an outer cooling device or it is needed to cool the operation room. This is not convenient for the doctor, nor for his assistants and nor for the patient. It is too cold for them and they use additional means for heating.

There are problem of cooling persons in electrical cars which use special electrical batteries. They may be sufficient for moving for some limited distance, but using them for air conditioning of the interior of the limits them considerably.

There are also problems of cooling persons acting in a normal atmosphere, but in a hot environment.

### SUMMARY

It is therefore one of the objects of the present invention to provide a heat protection suit that will help to cool the body in harsh environments.

The invention provides a device which permits an inexpensive, easy and rapid adaptation to the environment as needed. It can be used in dangerous atmospheres. The construction is such that there is an improved cooling effect and an extension of the effective use time without an increase in the weight.

According to the invention, the device includes pockets placed on inner and outer suits. These pockets may be closed or opened, all of them or part of them. They have dry ice in them. Dry ice (CO₂) is beneficial for the person and for the environment. Without being bound by theory, it is posed that as the dry ice evaporates, it cools the space between the inner and the outer suit and in this way cools the wearer. It is hypothesized that gas (CO₂) produces positive pressure in this space and that additionally protects the wearer from the penetration of dangerous gases, since the pressure within the suit is higher than that in the surrounding atmosphere.

It is possible to regulate the cooling effect by using different a number of pockets, varying their sizes and placement of their strengthening on the body, and by opening or closing the pockets.

The pockets are produced from thermo isolated materials to protect the wearer from contact with cold surfaces and to slow the evaporation of the dry ice. The device allows the wearer to act independently.

A further object of the invention is to provide a heat protection suit which is simple in design, economical to manufacture and permits a full range of motion of the user.

Other objects, features and advantages of the present invention will become apparent upon reading the following detailed description in conjunction with the drawings and the claims.

### BRIEF DESCRIPTION OF THE DRAWINGS

For a better understanding of the invention, its operating and specific objects attained by its uses, references should be had to accompanying drawings and descriptive matter in which there are illustrated preferred embodiments of the invention.

The invention will now be described in connection with certain preferred embodiments with reference to the following illustrative figures so that it may be more fully understood.

FIG. 1 is a left side, elevation view of the heat protective suit arranged on a wearer and constructed according to the invention.

FIG. 2 is a front elevation view of an alternate embodiment of the invention.

FIG. 3 is a left side elevation view of another alternate embodiment of the invention.

FIG. 4 is a front view of the heat protective suit for a wearer who acts in a normal atmosphere.

FIG. 5 is a side view of a heat protective suit for a surgeon.

FIG. 6 is a front view of an inner suit.

FIG. 7 is a view of a pocket.

FIG. 8 is a view of an open pocket.

### DETAILED DESCRIPTION OF ILLUSTRATIVE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In some embodiments, this invention provides a composite suit for protection of a wearer's body from heat. The composite suit comprises an inner suit covering at least a substantial portion of the wearer's body. In some embodiments, the phrase “covering at least a substantial portion of the wearer's body” refers to the fact that the inner suit may cover a significant portion of the exposed surface of the body, or the majority of the exposed surface of the body, but is not required to cover the entire exposed portion of the body. In some embodiments, the inner suit will cover the majority of the torso, or in some embodiments, the inner suit may cover the majority of the upper half of the body without covering the arms, or for example, without being long-sleeved, for example, by being short sleeved or sleeveless. The inner suit may according to any embodiment herein described cover the thighs of the wearer, or the majority of the thighs, or in some embodiments, the inner suit may extend down to the ankles, or in some embodiments, extend to the calves of the wearer. The inner suit may be comprised of a top and bottom connected by strips such that a portion or portions of the midriff of the wearer are not covered by the inner suit. It will be appreciated that any configuration of the inner suit where a large portion of the outer surface of the wearer's body is covered is envisioned, such that at least 51%, or 51-100%, or 65-90%, or 70-85% pf the outer surface of the wearer's body is covered.

The composite suit for protection of a wearer's body from heat will further comprise an outer suit overlying said inner suit and a plurality of at least 3-ply pockets located between the outer and inner suit, wherein a first and second ply of said 3-ply pocket are tightly apposed to each other, or said first and second ply of said 3-ply pocket surround a first void. It is to be understood that the first and second ply may be stitched together, or in some embodiments, the first and second ply may be separate layers, but apposed to each other, or in some embodiments, the first and second ply may surround a void. The first ply of said 3-ply pocket is positioned closest to said wearer's body and comprises or together with said second ply encloses a thermo insulating material. In some embodiments, the thermo insulating material is a polyurethane foam.

The third ply together with the second ply of the 3-ply pocket surrounds a second void wherein the third ply is positioned distally from a surface nearest the wearer's body and the second void, located between the third and second ply is sized to contain dry ice.

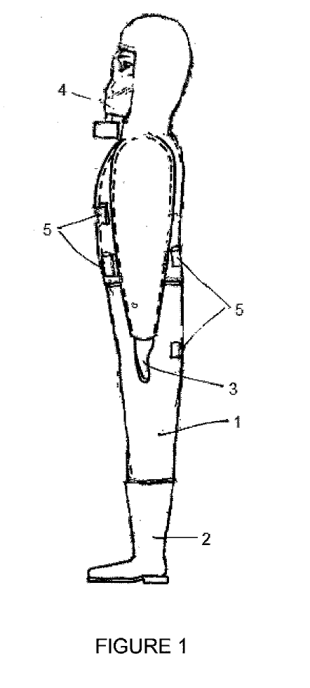

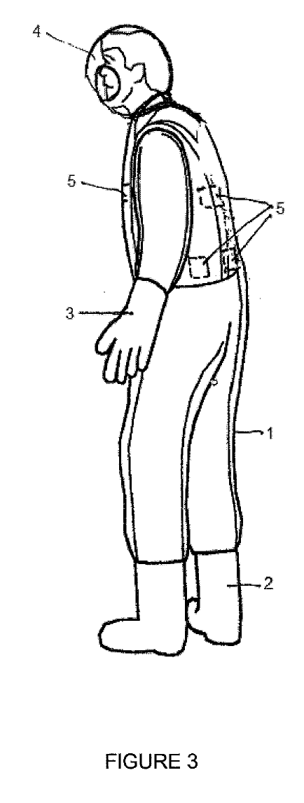

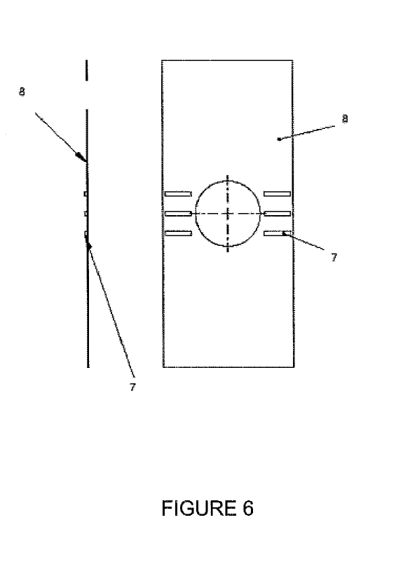

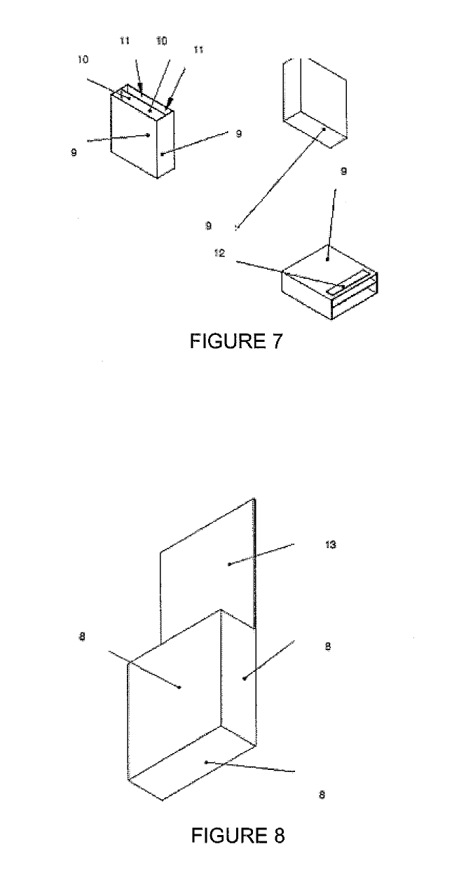

Referring to the drawings, and in particular FIGS. 1-3, the invention comprises a suit for protection of a wearer, which include, in some embodiments, an inner regular suit. In other embodiments, the inner suit may comprise a simple cotton fabric garment, for example, as depicted in FIG. 6 with an opening for insertion therethrough of a head of a wearer and a securing means, for example, Velcro strips for securing pockets thereto. An outer suit 1, which consists of a foot guard 2, a hand guard 3 and a head guard 4 is overlaid on the inner suit. Between the inner and outer suits, a system of pockets 5 is arranged. These pockets are of thermo isolating material with dry ice in them. The pockets may be closed 5 or opened 6 (FIGS. 7 and 8).

The suit wearer is surrounded by the outer suit 1, which consists of the head guard 4 with gasmask and foot guard 2 and hand guard 3.

The inner suit (FIG. 6) closely hugs the wearer's body surface. On the outer surface of the inner suit the system of pockets is also arranged, for example, by means of Velcro straps 7. These pockets are likewise made from a fabric 8 and thermo isolated materials with dry ice in them. A close up of an embodiment of such pockets is shown in FIG. 7. In some embodiments, an outer surface of the pockets 9 is made from light fabric—gauze. Such an arrangement may allow for better evaporation of the dry ice. As the dry ice evaporates it cools the wearer. The quantity of the pockets and their sizes is variable. It depends on the outer temperature and on the time of acting in the dangerous atmosphere. It is possible to close or to open the pockets, or just part of them. It allows regulating the cooling effect according to the desires and needs of the wearer.

The pocket may have two compartments, one suitable for insertion of dry ice 10, and one suitable for insertion of a thermo-isolating material, or a thermoisolating plate 11. The pocket may be attached to the suit by any means, for example, via Velcro strip 12.

If the pocket is closed, the cooling effect is at a minimum; and, if the pocket is opened, the cooling effect is at a maximum. The size of the pockets (which determines the quantity of dry ice) determines the available time in the dangerous atmosphere.

When dry ice evaporates, it creates a positive pressure in the outer suit and does not allow penetrating dangers gases into the suit, because pressure into the suit is more than in atmosphere. Surplus of the gas CO₂ will find way from the suit to the atmosphere, because the suit is not hermetic. CO₂ is a safe gas; it does not damage the wearer and the atmosphere.

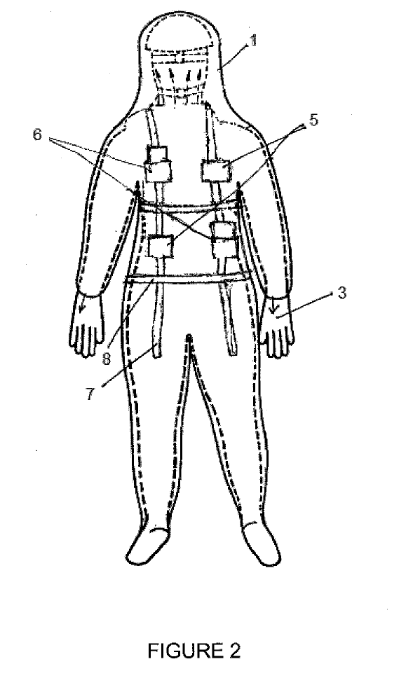

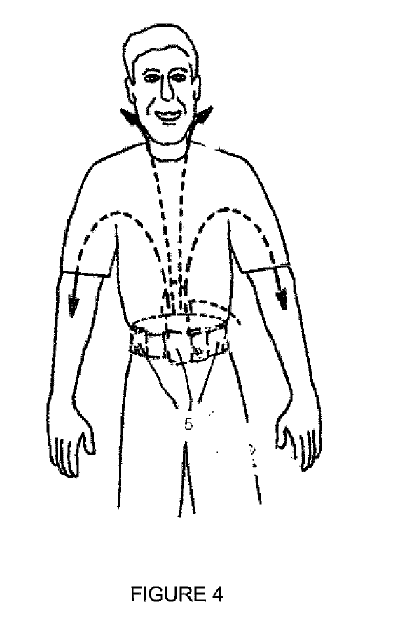

The system of the pockets may by arranged by adhesive attachment, for example by Velcro-based attachment on the system of the belts, which are arranged between the inner and outer suits in the horizontal and vertical directions (FIGS. 2 and 4).

The pocket preferably has two sections (FIG. 7). In one section, which is close to the body of the wearer, a plate from thermo insulated material or a plate from polyurethane foam is placed, for example. The plate does not allow be bad cold to body of a wearer. In the second section a plate of dry ice is placed.

The pockets may have covers 13 to open or to close the pockets, for example as depicted in FIG. 8. Such pockets may be provided with a closure means, such as a button, zipper, Velcro tab, etc.

In the embodiment shown in FIG. 4, only one horizontal belt with pockets 5 is used. The cooling gas cools the wearer. Such a suit may be used, for example, in a car, or during outside activity on a hot day or during work in a hot normal atmosphere.

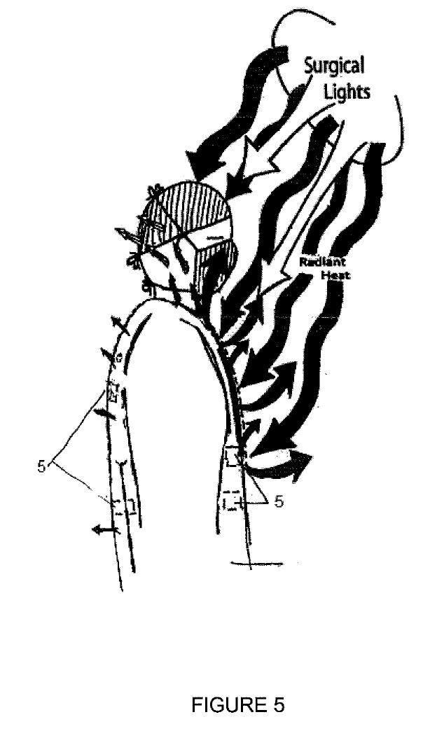

The embodiment of FIG. 5 shows a cooling suit for a surgeon during medical operations. It creates optimal climate conditions for the surgeon and his assistants and also for the patient.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Although the present invention has been described with reference to preferred embodiments, workers skilled in the art will recognize that changes may be made in form and detail without departing from the spirit and scope of the invention.

What is claimed is:

1. A composite suit for protection of a wearer's body from heat, comprising an inner suit covering at least a substantial portion of the wearer's body; an outer suit overlying said inner suit; and a plurality of at least 3-ply pockets wherein:
a first and second ply of said 3-ply pocket are tightly apposed to each other, or said first and second ply of said 3-ply pocket surround a first void wherein said first ply of said 3-ply pocket is positioned closest to said wearer's body and comprises or together with said second ply encloses a thermo insulating material; and
a third ply together with said second ply of said 3-ply pocket surrounds a second void wherein said third ply of said 3-ply pocket is positioned distally from a surface nearest the wearer's body and said second void is sized to contain dry ice.

2. The suit according to claim 1 wherein said thermo insulating material is polyurethane foam.

3. The suit according to claim 1 wherein said pockets have covers to open or to close the pocket.

4. The suit according to claim 1, further comprising a belt arranged on the body of the wearer and pockets with dry ice being arranged on said belt.

5. A device for protection of a wearer's body from heat, comprising:
a belt arranged on the body of the wearer; and a number of pockets with dry ice arranged on said belt.
